(19) United States
(12) Patent Application Publication
(10) Pub. No.: US 2005/0263915 A1
(43) Pub. Date: Dec. 1, 2005

(54) Imprinting method, information recording medium-manufacturing method, and imprinting apparatus

(75) Inventors: Minoru Fujita, Tokyo (JP); Kazuhiro Hattori, Tokyo (JP); Yoshikazu Soeno, Tokyo (JP); Mitsuru Takai, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/087,608

(22) Filed: Mar. 24, 2005

(30) Foreign Application Priority Data
May 27, 2004 (JP) 2004-156981

(51) Int. Cl. B29D 17/00

(52) U.S. Cl. 264/1.33; 264/322; 425/810; 425/406

(57) ABSTRACT

An imprinting method which is capable of forming a concave/convex pattern in a short time without causing deformation or incompleteness of the pattern. In the imprinting method, a stamper-pressing step of pressing a stamper against a resin layer formed by applying a resin material to a surface of a substrate, in a state of the resin layer being heated to a predetermined temperature, and a stamper-removing step of removing the stamper from the resin layer while maintaining either of the state of the resin layer being heated and a state of the temperature of the heated resin layer being held, are performed in the mentioned order, whereby shapes of recesses/protrusions of the stamper are transferred to the resin layer to form a concave/convex pattern on the substrate.

### BACKGROUND OF THE INVENTION

1. Field of the Invention

The present invention relates to an imprinting method and an imprinting apparatus, for forming a concave/convex pattern on a substrate by pressing a stamper against a resin layer formed on a surface of the substrate to thereby transfer the concave/convex pattern, and an information recording medium-manufacturing method for manufacturing an information recording medium using the concave/convex pattern formed on the substrate.

2. Description of the Related Art

Conventionally, photolithography has been known as a method of forming a fine concave/convex pattern (resist pattern) in a resist layer formed on a surface of a substrate, which is employed in processes for manufacturing semiconductor devices, information recording media, etc. The photolithography comprises irradiating the resist layer on the substrate with exposure light to form an exposure pattern in the resist layer, and then subjecting the resist layer to development treatment to thereby form a concave/convex pattern on the substrate. Further, in recent years, as a technique to meet the needs of higher-density semiconductor devices and larger-capacity information recording media, there has been developed electron beam lithography which uses an electron beam in place of light to draw a nanometer-sized pattern to thereby form a concave/convex pattern. The electron beam lithography, however, takes a long time to draw the pattern on the resist layer, which makes it difficult to execute mass production of semiconductor devices and information recording media.

As a solution to the above problem, nanoimprint lithography (imprinting method of forming a nanometer-sized concave/convex pattern: hereinafter also referred to as the “imprinting method”) is disclosed in U.S. Pat. No. 5,772,905, in which a stamper (mold) having a nanometer-sized concave/convex pattern formed thereon is pressed against a resin layer on a substrate to transfer the shapes of recesses/protrusions of the stamper to the resin layer, thereby forming the nanometer-sized concave/convex pattern on the substrate. In this imprinting method, first, the stamper is manufactured such that it has the nanometer-sized concave/convex pattern (minimum width thereof is approximately e.g. 25 nm) formed on a transferring surface thereof. More specifically, a desired pattern is drawn on a silicon substrate having a silicon oxide layer formed on a surface thereof using a electron beam lithography apparatus, and then etching treatment is performed on the substrate by a reactive ion etching apparatus to form a concave/convex pattern. The stamper is thus manufactured.

Next, for example, polymethyl methacrylate (PMMA) is spin-coated on a surface of a silicon substrate to form a resin layer having a thickness of approximately 55 nm. Then, the laminate of the substrate and the resin layer, and the stamper are both heated to a temperature (e.g. approximately 200° C.) not lower than 105° C., which is a glass transition temperature of PMMA, and then the stamper is pressed against the resin layer on the substrate at a pressure of 13.1 MPa (133.6 kgf/cm²). Subsequently, the laminate with the stamper pressed against the same is allowed to stand (cooling process) until the temperature thereof becomes room temperature, whereafter the stamper is removed from the resin layer. This transfers the concave/convex pattern of the stamper to the resin layer, whereby a nanometer-sized concave/convex pattern is formed on the substrate.

### SUMMARY OF THE INVENTION

As a result of the study of the conventional imprinting method, however, the present inventors found the following problems: In the imprinting method, both of the laminate of the substrate and the resin layer, and the stamper are heated to approximately 200° C. when the stamper is pressed against the resin layer, and cooled to room temperature before the stamper is removed from the resin layer. The thermal expansion coefficient of the substrate having the resin layer formed thereon and that of the stamper are different from each other, so that there occurs a difference in the amount of shrinkage between the substrate and the stamper caused during the cooling process. Therefore, when the stamper is removed from the laminate, the resin layer (resin material) having entered concave portions of the concave/convex pattern of the stamper receives a force which causes the resin layer to move together with the stamper (force causing the resin layer to move away from the substrate), whereby the resin layer (resin material) is sometimes deformed from a state provided with desired shapes of recesses/protrusions, or has portions thereof stripped off the substrate due to the deformation. For this reason, the conventional imprinting method suffers from the problem of possibility of deformation or incompleteness of a concave/convex pattern formed on the substrate.

Further, in the conventional imprinting method, the stamper is removed from the resin layer after subjecting both the laminate of the substrate and the resin layer, and the stamper to the cooling process. In this case, if the laminate and the stamper are rapidly cooled, there is a fear that the substrate is damaged (cracked) due to the rapid decrease in temperature. Therefore, it is required to take much time to cool the laminate and the stamper once heated to approximately 200° C. to ordinary temperature. For this reason, the conventional imprinting method suffers from the problem that it takes a relatively long time to form the concave/convex pattern.

The present invention has been made in view of the above problems, and a main object thereof is to provide an imprinting method, an imprinting apparatus, and an information recording medium-manufacturing method, which are capable of forming a concave/convex pattern in a short time period without causing deformation or incompleteness of the concave/convex pattern.

To attain the above object, in a first aspect of the present invention, there is provided an imprinting method comprising a stamper-pressing step of pressing a stamper against a resin layer formed by applying a resin material to a surface of a substrate, in a state of the resin layer being heated to a predetermined temperature, and a stamper-removing step of removing the stamper from the resin layer while maintaining either of the state of the resin layer being heated and a state of the temperature of the heated resin layer being held, wherein the stamper-pressing step and the stamper-removing step are performed in the mentioned order, whereby shapes of recesses/protrusions of the stamper are transferred to the resin layer to form a concave/convex pattern on the substrate. It should be noted that in the present invention, the term “state of the temperature of the heated resin layer being held” is intended to mean “state where heat treatment on the resin layer is terminated”, more specifically, “state where the resin layer is allowed to stand within a thermally insulated space, such as a temperature controlled bath (state where rapid decrease in temperature is prevented)”.

To attain the above object, in a second aspect of the present invention, there is provided an imprinting apparatus including heating section for heating a resin layer formed by applying a resin material to a surface of a substrate, a moving mechanism for pressing a stamper against the resin layer and removing the pressed stamper from the resin layer, and a control section for controlling the heating section and the moving mechanism, the imprinting apparatus being configured to be capable of transferring shapes of recesses/protrusions of the stamper to the resin layer to form a concave/convex pattern on the substrate, wherein the control section causes the heating section to heat the resin layer to a predetermined temperature, and the moving mechanism to press the stamper against the resin layer, and thereafter causes the moving mechanism to remove the stamper from the resin layer while maintaining either of the state of the resin layer being heated and a state of the temperature of the heated resin layer being held.

According to these imprinting method and imprinting apparatus, in the stamper-removing step, the stamper is removed from the resin layer while maintaining either of the state of the resin layer being heated and the state of the temperature of the heated resin layer being held, thereby preventing both the substrate and the stamper from undergoing almost any change in their temperatures during a time period from a time point when the stamper is pressed against the resin layer to a time point when the stamper is removed from the resin layer, so that it is possible to form a concave/convex pattern without causing thermal expansion or thermal shrinkage in the substrate and the stamper. Further, since there is no need to allow the substrate and the stamper to stand until the temperatures thereof become ordinary temperature, that is, since the cooling process can be dispensed with, it is possible to produce a large number of intermediates for manufacturing information recording media, for example, which have the concave/convex pattern formed on a substrate thereof, in a short time.

To attain the above object, in a third aspect of the present invention, there is provided an imprinting method comprising a stamper-pressing step of pressing a stamper against a resin layer formed by applying a resin material to a surface of a substrate, in a state of the resin layer being heated to a predetermined temperature, and a stamper-removing step of terminating heating of the resin layer and removing the stamper from the resin layer in a state of the temperature of the resin layer being substantially the same as the predetermined temperature, wherein the stamper-pressing step and the stamper-removing step are performed in the mentioned order, whereby shapes of recesses/protrusions of the stamper are transferred to the resin layer to form a concave/convex pattern on the substrate. It should be noted that in the present invention, the term “state of the temperature of the resin layer being substantially the same as the predetermined temperature” is intended to mean “state of the resin layer before the temperature thereof becomes not less than 10° C. lower than a temperature (predetermined temperature) at which the stamper-pressing step is performed”.

To attain the above object, in a fourth aspect of the present invention, there is provided an imprinting apparatus including heating section for heating a resin layer formed by applying a resin material to a surface of a substrate, a moving mechanism for pressing a stamper against the resin layer and removing the pressed stamper from the resin layer, and a control section for controlling the heating section and the moving mechanism, the imprinting apparatus being configured to be capable of transferring shapes of recesses/protrusions of the stamper to the resin layer to form a concave/convex pattern on the substrate, wherein the control section causes the heating section to heat the resin layer to a predetermined temperature, and the moving mechanism to press the stamper against the resin layer, and thereafter causes the heating section to terminate heating of the resin layer, and the moving mechanism to remove the stamper from the resin layer in a state of the temperature of the resin layer being substantially the same as the predetermined temperature.

According to these imprinting method and imprinting apparatus, in the stamper-removing step, the stamper is removed from the resin layer in the state in which the temperature of the resin layer is substantially the same as the temperature (predetermined temperature) at which the stamper-pressing step is performed. This makes it possible to sufficiently reduce changes in the temperatures of both of the substrate and the stamper, occurring during the time period from the time point when the stamper is pressed against the resin layer to the time point when the stamper is removed from the resin layer. Therefore, it is possible to sufficiently reduce the difference in the amount of shrinkage between the substrate and the stamper, so that it is possible to form a concave/convex pattern without any deformation or incompleteness, or with very little deformation or very few defective portions.

In the above case, in the stamper-pressing step, the resin layer can be heated by setting the predetermined temperature to a temperature not lower than the glass transition temperature of the resin material. This makes it possible to easily push convex portions of the concave/convex pattern of the stamper into the resin layer. As a result, it is possible to accurately and easily transfer the concave/convex pattern of the stamper to the resin layer on the substrate to form a concave/convex pattern thereon.

To attain the above object, in a fifth aspect of the present invention, there is provided a method of manufacturing an information recording medium using the concave/convex pattern formed on the substrate by the aforementioned imprinting method.

According to this information recording medium-manufacturing method, an information recording medium is manufactured using the concave/convex pattern formed on the substrate by the imprinting method described above. Therefore, the concave/convex pattern does not suffer from deformation or incompleteness, so that it is possible to manufacture an information recording medium which is free from a recording error or a reproduction error which can be caused by the deformation or incompleteness of the pattern.

It should be noted that the present disclosure relates to the subject matter included in Japanese Patent Application No. 2004-156981 filed May 27, 2004, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a block diagram showing the arrangement of an imprinting apparatus;

FIG. 2 is a cross-sectional view showing the construction of an intermediate;

FIG. 3 is a cross-sectional view showing the construction of a stamper;

FIG. 4 is a cross-sectional view of a disk-shaped substrate having a resist layer formed thereon in a process for manufacturing a stamper;

FIG. 5 is a cross-sectional view of the disk-shaped substrate and the resist layer, in a state in which the resist layer in the state shown in FIG. 4 is irradiated with an electron beam to have an exposure pattern drawn (a latent image formed) therein;

FIG. 6 is a cross-sectional view of the disk-shaped substrate and the resist layer, in a state in which the resist layer in the state shown in FIG. 5 is subjected to development treatment to form a concave/convex pattern on the disk-shaped substrate;

FIG. 7 is a cross-sectional view of the disk-shaped substrate and the concave/convex pattern, in a state in which an electrode film is deposited in a manner covering the concave/convex pattern shown in FIG. 6;

FIG. 8 is a cross-sectional view of a laminate of the disk-shaped substrate, the resist layer, the electrode film, and a nickel layer, in a state in which the nickel layer is deposited in a manner covering the electrode film shown in FIG. 7;

FIG. 9 is a cross-sectional view of the disk-shaped substrate, the electrode film, and the nickel layer, in a state in which a laminate of the electrode film and the nickel layer is removed from the disk-shaped substrate by dissolving the resist layer of the laminate in the FIG. 8 state;

FIG. 10 is a cross-sectional view of the intermediate and the stamper, in a state in which the stamper is positioned above the intermediate;

FIG. 11 is a cross-sectional view of the intermediate and the stamper, in a state in which the stamper is pressed against the resin layer of the intermediate;

FIG. 12 is a cross-sectional view of the intermediate and the stamper, in a state in which the intermediate shown in the FIG. 11 state has the stamper removed therefrom to form a concave/convex pattern thereon;

FIG. 13 is a cross-sectional view of the intermediate in a state in which a concave/convex pattern is formed by etching a metal layer using the concave/convex pattern shown in FIG. 12; and

FIG. 14 a cross-sectional view of an information recording medium formed using the concave/convex pattern shown in FIG. 13.

### DESCRIPTION OF THE PREFERRED EMBODIMENTS

Hereafter, an imprinting method, a method of manufacturing an information recording medium, and an imprinting apparatus, according to a preferred embodiment of the present invention, will be described with reference to the accompanying drawings.

First, a description will be given of the arrangement of the imprinting apparatus 1 according to the present invention.

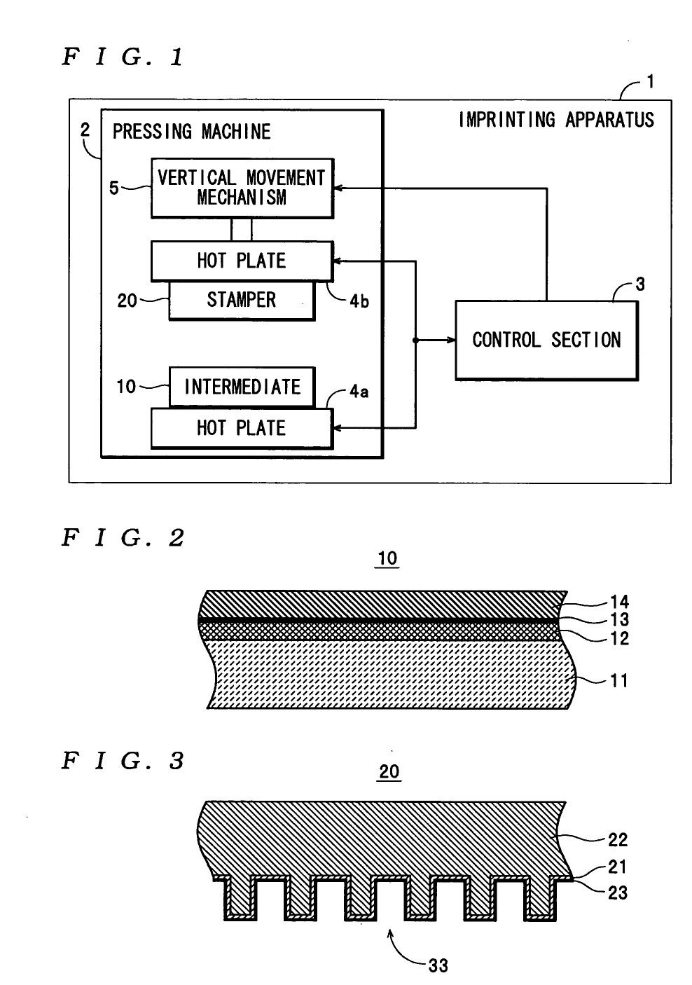

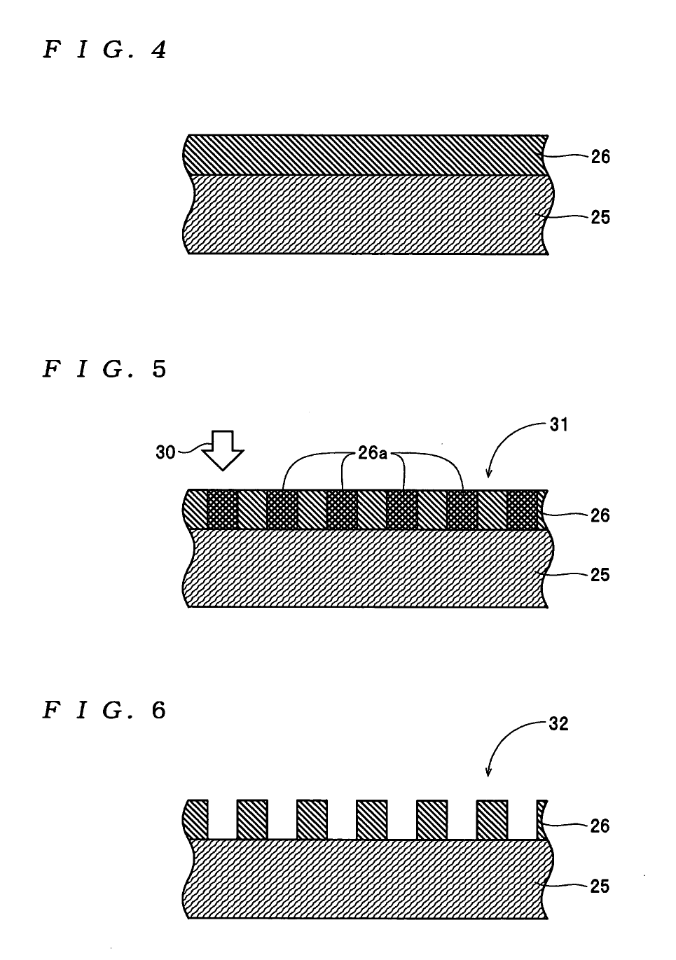

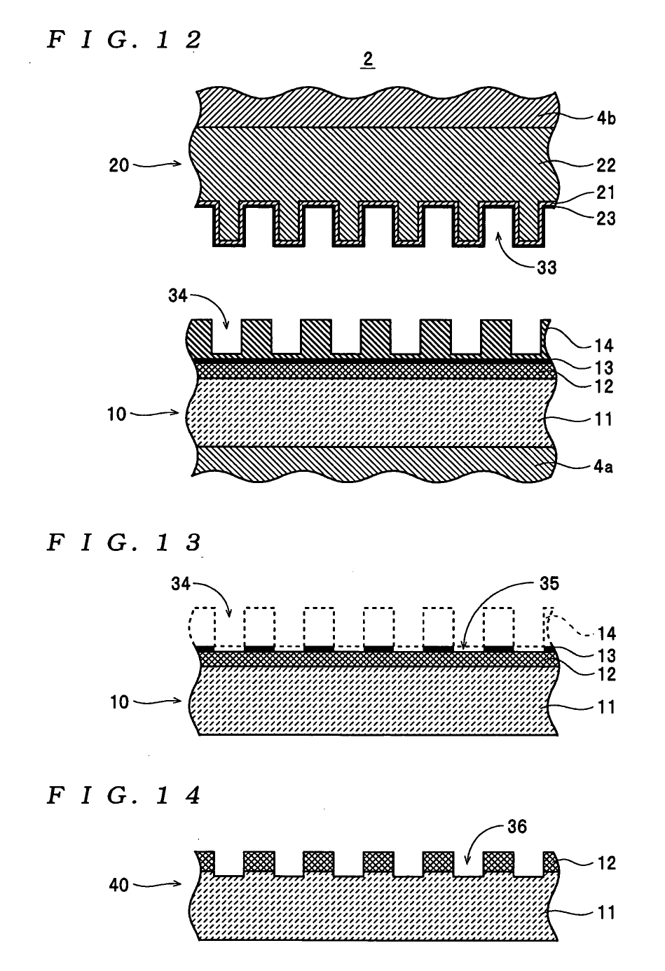

The imprinting apparatus 1 shown in FIG. 1 forms a concave/convex pattern 34 (see FIG. 12) by pressing a stamper 20 (see FIG. 3) against an intermediate 10 (see FIG. 2) by the imprinting method of the present invention, in manufacturing the information recording medium 40 shown in FIG. 13, and is comprised of a pressing machine 2, and a control section 3. In this embodiment, the information recording medium 40 is a discrete track-type magnetic recording medium, and formed with a concave/convex pattern 36 comprised of a large number of concentric data-recording tracks, servo patterns and the like separated from each other with a predetermined arrangement pitch (e.g. 150 nm). The construction etc. of the discrete track-type magnetic recording medium are known, and hence detailed description and illustration thereof are omitted.

As shown in FIG. 2, the intermediate 10 is comprised of a magnetic layer 12, a metal layer 13, and a resin layer 14 sequentially deposited on a disk-shaped substrate 11 made of e.g. silicon, glass or ceramic. Although actually, there are provided various functional layers, such as a soft magnetic layer and an alignment layer, between the disk-shaped substrate 11 and the magnetic layer 12, description and illustration thereof are omitted for ease of understanding of the present invention. Further, in the illustrated example, the substrate in the present invention is comprised of the disk-shaped substrate 11, the magnetic layer 12, and the metal layer 13. Further, as described hereinafter, to form excellent shapes of recesses/protrusions of the concave/convex pattern 34 when the stamper 20 is removed, it is preferable to use e.g. a polystyrene resin, a methacrylate resin (PMMA), polystyrene, a phenol resin, or a novolak resin, as a resin material forming the resin layer 14. In the illustrated example, it is assumed that the novolak resin is used to form the resin layer 14 having a thickness within a range of 40 to 100 nm.

On the other hand, as shown in FIG. 3, the stamper (mold) 20 is a laminate of an electrode film 21 and a nickel layer 22, is formed in a disk shape across the entire layer, and has a surface (lower surface as viewed in FIG. 3) formed with a concave/convex pattern 33 for forming a concave/convex pattern on the resin layer 14 of the intermediate 10. Further, as described hereinafter, in order to prevent the resin material from adhering to the stamper 20 when the stamper 20 is removed from the resin layer 14, the surface (surface of the concave/convex pattern 33) of the electrode film 21 of the stamper 20 is coated e.g. with a fluorine-based material, whereby the stamper 20 is formed with an adhesive force-reducing film 23. The material forming the adhesive force-reducing film 23 is not limited to the fluorine-based coating material, but it is possible to employ various materials which are capable of reducing the adhesive force of the resin layer 14.

Referring to FIG. 1, the pressing machine 2 includes hot plates 4a and 4b, and a vertical movement mechanism 5. The hot plates 4a and 4b (hereinafter also referred to as the “hot plates 4” when they are not distinguished from each other) corresponds to heating section in the present invention, and heats the intermediate 10 and the stamper 20 under the control of the control section 3. Further, the hot plate 4a is configured to be capable of holding the intermediate 10 such that the surface thereof on which the resin layer 14 is formed faces upward, while the hot plate 4b is configured to be capable of holding the stamper 20 such that the surface thereof on which the concave/convex pattern 33 is formed faces downward. The vertical movement mechanism 5 corresponds to a moving mechanism in the present invention, and moves (lowers) the hot plate 4b toward the intermediate 10 held by the hot plate 4a to thereby press the stamper 20 held by the hot plate 4b against the resin layer 14 of the intermediate 10. Further, the vertical movement mechanism 5 causes the hot plate 4b to move (be lifted) away from the hot plate 4a, whereby the stamper 20 pressed against the resin layer 14 is removed from the resin layer 14. The control section 3 causes the hot plates 4 to heat both of the intermediate 10 and the stamper 20, and causes the vertical movement mechanism 5 to press the stamper 20 against the intermediate 10 (stamper-pressing step in the present invention), and remove the stamper 20 pressed against the intermediate 10 from the intermediate 10 (stamper-removing step in the present invention).

Next, a process for forming the concave/convex pattern on the intermediate 10 by the imprinting method according to the present invention will be described with reference to drawings.

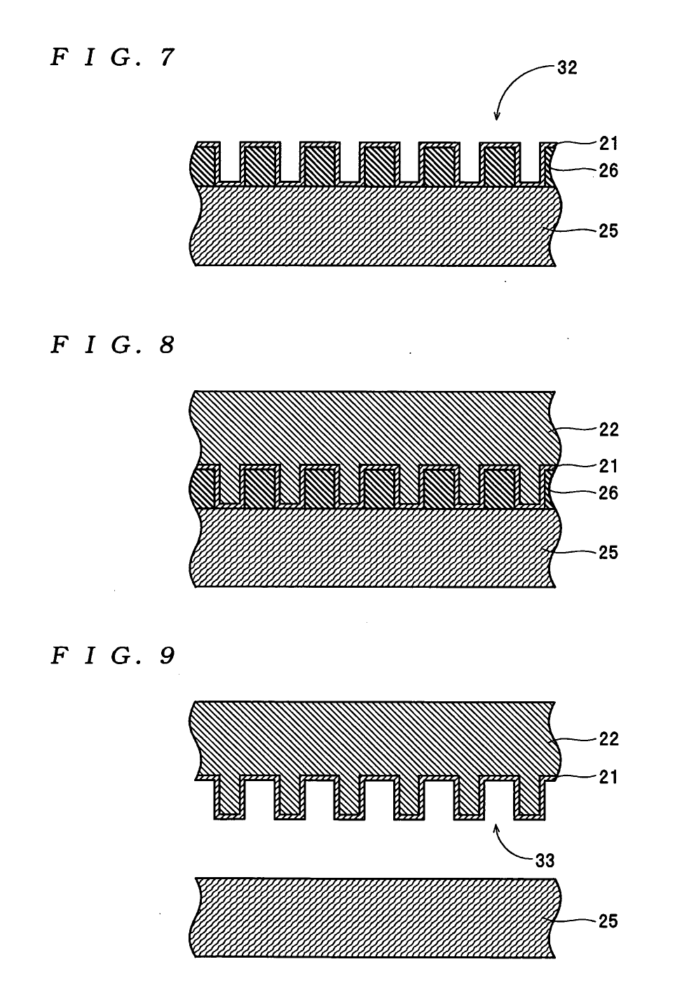

First, the stamper 20 is fabricated. More specifically, as shown in FIG. 4, first, resist is spin-coated on a disk-shaped silicon substrate 25 polished such that it has an even surface, whereby a resist layer 26 is formed on the surface of the disk-shaped substrate 25. It should be noted that the substrate used for manufacturing the stamper is not limited to the silicon substrate, but it is possible to employ various substrates, such as a glass substrate and a ceramic substrate. Then, as shown in FIG. 5, the resist layer 26 is irradiated with an electron beam 30 by an electron beam lithography apparatus to draw a desired exposure pattern 31 in the resist layer 26. Subsequently, development treatment is executed on the resist layer 26 in this state to thereby eliminate portions formed with a latent image 26a. As a result, as shown in FIG. 6, a concave/convex pattern 32 is formed on the disk-shaped substrate 25, whereby a master disk is completed. It should be noted that the master disk can also be formed by performing etching treatment on the disk-shaped substrate 25 using the resist layer 26 remaining on the disk-shaped substrate 25 as a mask to thereby engrave the concave/convex pattern 32 in the disk-shaped substrate 25.

Then, as shown in FIG. 7, an electroforming electrode film 21 is formed along the shapes of recesses/protrusions of the concave/convex pattern 32 on the master disk, whereafter an electroforming process is executed using the electrode film 21 as an electrode, to form the nickel layer 22 as shown in FIG. 8. Subsequently, the resist layer 26 is eliminated by soaking the laminate of the disk-shaped substrate 25, the resist layer 26, the electrode film 21, and the nickel layer 22 into a resist-eliminating liquid, whereby as shown in FIG. 9, the laminate of the electrode film 21 and the nickel layer 22 is removed from the disk-shaped substrate 25. This causes the concave/convex pattern 32 on the master disk to be transferred to the laminate of the electrode film 21 and the nickel layer 22 to thereby form the concave/convex pattern 33. After that, the reverse side of the nickel layer 22 is shaped by polishing the same such that it has an even surface, and the surface of the electrode film 21 is coated with a fluorine-based material to form the adhesive force-reducing film 23. Thus, the stamper 20 is completed, as shown in FIG. 3.

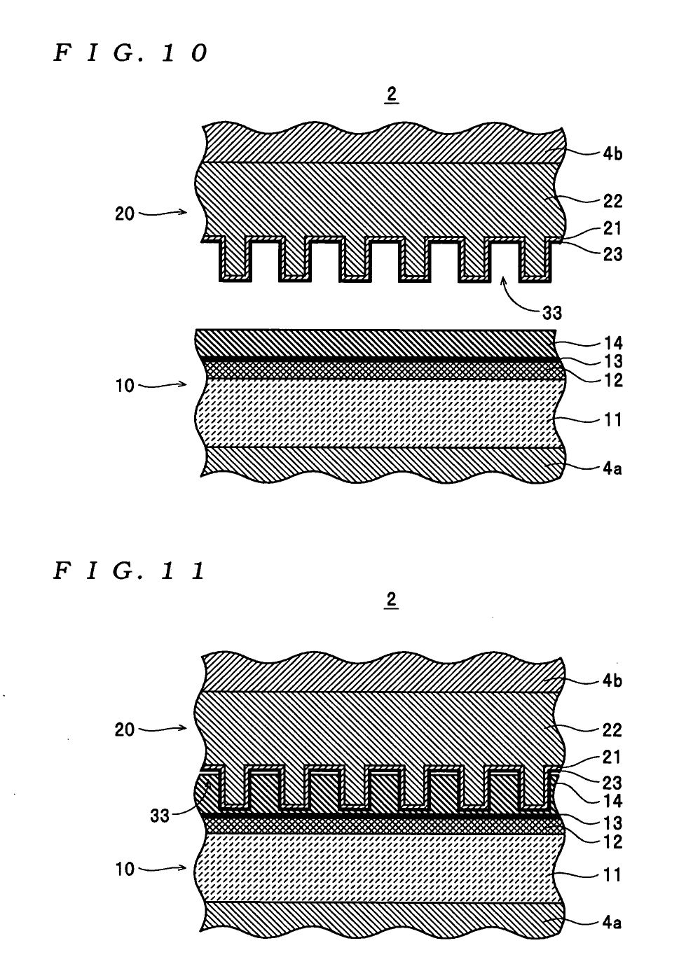

Next, the intermediate 10 and the stamper 20 are set in the pressing machine 2. More specifically, as shown in FIG. 10, the intermediate 10 is mounted on the hot plate 4a such that the surface thereof on which the resin layer 14 is formed faces upward, and the stamper 20 is mounted on the hot plate 4b such that the surface thereof on which the concave/convex pattern 33 is formed faces downward. Then, the control section 3 controls the hot plates 4a and 4b to heat both of the intermediate 10 and the stamper 20. In doing this, the hot plates 4a and 4b heat the intermediate 10 and the stamper 20 to a temperature of approximately 170° C. (example of a predetermined temperature in the present invention) which is approximately 100° C. higher than the glass transition temperature (approximately 70° C. in the illustrated example) of the novolak resin forming the resin layer 14. This softens the resin layer 14 into an easily deformable state. In this case, it is preferred that the hot plates 4a and 4b heat the intermediate 10 and the stamper 20 to a temperature higher than the glass transition temperature of the resin material by a range of 70 to 120° C., and more preferably by not less than 100° C. This makes it possible to press the stamper 20 against the resin layer 14 with ease.

Subsequently, the control section 3 causes the vertical movement mechanism 5 to lower the hot plate 4b toward the hot plate 4a, whereby as shown in FIG. 11, the stamper 20 is pressed against the resin layer 14 of the intermediate 10 on the hot plate 4a (stamper-pressing step in the present invention). When pressing the stamper 20, the vertical movement mechanism 5 under the control of the control section 3 maintains a state where it applies load of e.g. 34 kN to the stamper 20, for five minutes. Further, while the stamper 20 is being pressed against the intermediate 10 by the vertical movement mechanism 5 under the control of the control section 3, the hot plates 4a and 4b continue heating the intermediate 10 and the stamper 20 to prevent the temperatures thereof from lowering. It is preferred that the temperatures of the intermediate 10 and the stamper 20 are held within a range of 170° C.±1° C. (e.g. within a range of ±0.2° C.) during execution of the above heat treatment.

Then, as shown in FIG. 12, while causing the hot plates 4a and 4b to continue the heat treatment (while holding the temperature within the range of 170° C.±1° C.), the control section 3 causes the vertical movement mechanism 5 to lift the hot plate 4b to thereby remove the stamper 20 from the intermediate 10 (resin layer 14) (stamper-removing step in the present invention). This causes the concave/convex pattern 33 on the stamper 20 to be transferred onto the resin layer 14 on the intermediate 10, whereby the concave/convex pattern 34 is formed on the magnetic layer 12. In this case, in the imprinting apparatus 1, both of the intermediate 10 and the stamper 20 are heated up to a temperature of approximately 170° C. prior to the start of the stamper-pressing step, and the heat treatment on the intermediate 10 and the stamper 20 is continuously executed until completion of the stamper-removing step so as to cause both of the intermediate 10 and the stamper 20 to have a temperature of approximately 170° C. Therefore, there hardly occurs any change in the temperatures of the intermediate 10 and the stamper 20 during a time period from a time point when the convex portions of the concave/convex pattern 33 on the stamper 20 are pushed into the resin layer 14 to a time point when the stamper 20 is removed, so that the transfer of the concave/convex pattern 33 is completed without causing thermal expansion or thermal shrinkage in the intermediate 10 and the stamper 20. As a result, it is possible to avoid the inconvenience of the concave/convex pattern 33 suffering from deformation or incompleteness.

Next, a process for manufacturing the information recording medium 40 according to the information recording medium-manufacturing method of the present invention will be described with reference to drawings.

First, the resin material (residue) remaining on a bottom surface of each concave portion of the concave/convex pattern 34 on the resin layer 14 is removed by an oxygen plasma treatment. Then, etching treatment using a gas for metal etching is performed using (the convex portions of) the concave/convex pattern 34 as a mask. At this time, as shown in FIG. 13, the metal layer 13 formed on the bottom surface of each concave portion of the concave/convex pattern 34 is removed, whereby a concave/convex pattern 35 made of metal material is formed on the magnetic layer 12. Subsequently, etching treatment using a gas for the magnetic material is performed using the concave/convex pattern 35 (remaining portions of the metal layer 13) as a mask, whereby portions of the magnetic layer 12 exposed from the concave/convex pattern 35 are removed. Then, etching treatment using a gas for metal etching is performed to thereby remove the portions of the metal layer 13 remaining on the magnetic layer 12. As a result, as shown in FIG. 14, grooves with the same pitch as the arrangement pitch of the concave portions of the concave/convex pattern 34 formed by transfer of the shapes of recesses/protrusions of the stamper 20 are formed in a track-forming area of the magnetic layer 12, whereby discrete tracks comprised of portions of the magnetic layer 12 separated by the grooves from each other are formed.

Next, surface-finishing treatment is executed. In the surface-finishing treatment, first, the grooves (not shown) are filled with e.g. silicon dioxide and then the surfaces of the discrete tracks and the silicon dioxide are flattened by a CMP (chemical mechanical polishing) device. Then, a protective film is formed on the flattened surfaces e.g. by DLC (Diamond Like Carbon), and finally lubricant is applied to the protective film. Thus, the information recording medium 40 is completed. Since the information recording medium 40 is manufactured using the concave/convex pattern 34 free from deformation and incompleteness, so that the concave/convex pattern 36 (data-recording tracks, servo patterns, and the like) formed by using the concave/convex pattern 34 (concave/convex pattern 35) are also free from deformation and incompleteness. This makes it possible to prevent occurrence of a recording error or a reproduction error.

In contrast, instead of executing the imprinting method, if both of the intermediate 10 and the stamper 20 are cooled to approximately 60° C. before the stamper 20 is removed from the intermediate 10, and then the stamper 20 is removed from the resin layer 14, there occurs deformation in the concave/convex pattern 34 on the magnetic layer 12, and incompleteness of the pattern (peeling of portions of the resin layer 14 from the magnetic layer 12) at largely deformed portions of the concave/convex pattern 34. More specifically, the thermal expansion coefficient of the stamper 20 is higher than that of the disk-shaped substrate 11, so that when both of the intermediate 10 and the stamper 20 are cooled before the stamper 20 is removed from the intermediate 10, the stamper 20 is more largely shrunk than the resin layer 14. Therefore, the concave/convex pattern 34 on the magnetic layer 12 is sometimes deformed such that it is displaced toward the center of the disk-shaped substrate 11. For this reason, when the information recording medium 40 is manufactured using the concave/convex pattern 34 formed by removing the stamper 20 after cooling the intermediate 10 and the stamper 20, the concave/convex pattern 36 as well suffers from deformation or incompleteness, so that it becomes difficult to prevent occurrence of a recording error or a reproduction error.

As described above, according to the imprinting method implemented by the imprinting apparatus 1, during the stamper-removing step, the stamper 20 is removed from the resin layer 14 while maintaining the state of the resin layer 14 being heated, whereby there hardly occurs any change in the temperatures of the intermediate 10 and the stamper 20 during a time period from a time point when the stamper 20 is pressed against the resin layer 14 to a time point when the stamper 20 is removed from the resin layer 14. This makes it possible to form the concave/convex pattern without causing any thermal expansion or thermal shrinkage in either of the intermediate 10 and the stamper 20. Further, since there is no need to allowing the intermediate 10 and the stamper 20 to stand until the temperatures thereof become ordinary temperature, that is, the cooling process can be dispensed with, it is possible to produce a large number of intermediates 10 having the concave/convex pattern 34 formed on the magnetic layer 12 thereof in a short time.

Further, according to the imprinting method implemented by the imprinting apparatus 1, during the stamper-pressing step, the resin layer 14 is heated to a temperature (170° C. in the above example) not lower than the glass transition temperature of a resin material (approximately 70° C. in the above example, which is the glass transition temperature of the novolak resin used for forming the resin layer 14), whereby the convex portions of the concave/convex pattern 33 of the stamper 20 can be easily pushed into the resin layer 14. This makes it possible to accurately and easily transfer the concave/convex pattern 33 of the stamper 20 onto the resin layer 14 on the magnetic layer 12 to form the concave/convex pattern 34.

Furthermore, the information recording medium 40 is manufactured using the concave/convex pattern 34 formed on a substrate (laminate of the disk-shaped substrate 11 and the magnetic layer 12, in the above example) by the above-described imprinting method, so that the concave/convex pattern 36 is free from deformation and incompleteness. This makes it possible to manufacture the information recording medium 40 which is free from occurrence of a recording error or a reproduction error which can be caused by the deformation or incompleteness of the pattern.

It should be noted that the present invention is not limited to the above-described construction and method. For example, although in the imprinting apparatus 1, the heat treatment on both of the intermediate 10 and the stamper 20 is continuously executed during a time period from a time point before the start of the stamper-pressing step in which the stamper 20 is pressed against the intermediate 10 until a time point of completion of the stamper-removing step in which the stamper 20 is removed from the intermediate 10, this is not limitative, but it is also possible, for example, to terminate the heat treatment on both of the intermediate 10 and the stamper 20 after the stamper 20 is pressed against the intermediate 10 to a certain sufficiently degree, and then employ a step in which the stamper 20 is removed before the temperatures of the intermediate 10 and the stamper 20 are largely lowered (in a state where the temperatures of the intermediate 10 and the stamper 20 are substantially the same as a temperature thereof at which the stamper-pressing step is performed: e.g. before the temperatures of the intermediate 10 and the stamper 20 become not less than 10° C. lower than the temperature thereof at which the stamper-pressing step is performed).

Although in the above case, by starting the stamper-removing step as early as possible after termination of the heat treatment, the removal of the stamper 20 can be completed before the temperatures of the intermediate 10 and the stamper 20 are largely lowered, it is preferable to maintain the temperatures of the intermediate 10 and the stamper 20 such that the temperatures are not rapidly lowered during the stamper-pressing step and the stamper-removing step. In doing this, it is more preferable to maintain the temperatures of the intermediate 10 and the stamper 20 such that the temperatures do not become lower than the glass transition temperature of the resin material forming the resin layer 14. This makes it possible to sufficiently reduce the difference in the amount of shrinkage between the intermediate 10 (the disk-shaped substrate 11) and the stamper 20 caused before completion of removal of the stamper, compared with the conventional imprinting method in which the stamper is removed after the laminate and the stamper are cooled to a temperature much lower than the glass transition temperature of the resin material. As a result, similarly to the formation of the concave/convex pattern 34 by the imprinting apparatus 1, it is possible to form a concave/convex pattern which is free from deformation or incompleteness, or with very little deformation and very few defective portions.

Further, the heating section for heating the intermediate 10 and the stamper 20 is not limited to the hot plates 4 of the imprinting apparatus 1, but it is possible to employ various types of heating devices, such as heating devices that electrically or electromagnetically heat the intermediate 10 and the stamper 20, and heating devices that heat the intermediate 10 and the stamper 20 using a heat wave. Furthermore, although in the above imprinting apparatus 1, the concave/convex pattern 34 is formed on one surface of the disk-shaped substrate 11 by pressing a single stamper 20 against the intermediate 10 having the resin layer 14 formed on the one surface of the disk-shaped substrate 11 thereof, this is not limitative, but it is also possible to form concave/convex patterns on both the front and reverse surfaces of the substrate of the intermediate by pressing two stampers against the intermediate having resin layers formed on the opposite surfaces of the substrate thereof in a manner sandwiching the same. Additionally, the use of the concave/convex pattern formed by the imprinting method according to the present invention is not limited to manufacturing of discrete track-type information recording media, but the concave/convex pattern can be employed for manufacturing patterned media including patterns other than the track-shaped patterns, and devices (e.g. electronic component parts) other than the information recording media.

1. An imprinting method comprising:
a stamper-pressing step of pressing a stamper against a resin layer formed by applying a resin material to a surface of a substrate, in a state of the resin layer being heated to a predetermined temperature; and
a stamper-removing step of removing the stamper from the resin layer while maintaining either of the state of the resin layer being heated and a state of the temperature of the heated resin layer being held,
wherein the stamper-pressing step and the stamper-removing step are performed in the mentioned order, whereby shapes of recesses/protrusions of the stamper are transferred to the resin layer to form a concave/convex pattern on the substrate.

2. An imprinting method comprising:
a stamper-pressing step of pressing a stamper against a resin layer formed by applying a resin material to a surface of a substrate, in a state of the resin layer being heated to a predetermined temperature; and
a stamper-removing step of terminating heating of the resin layer and removing the stamper from the resin layer in a state of the temperature of the resin layer being substantially the same as the predetermined temperature,
wherein the stamper-pressing step and the stamper-removing step are performed in the mentioned order, whereby shapes of recesses/protrusions of the stamper are transferred to the resin layer to form a concave/convex pattern on the substrate.

3. The imprinting method as claimed in claim 1,
wherein in the stamper-pressing step, the resin layer is heated by setting the predetermined temperature to a temperature not lower than a glass transition temperature of the resin material.

4. The imprinting method as claimed in claim 2,
wherein in the stamper-pressing step, the resin layer is heated by setting the predetermined temperature to a temperature not lower than a glass transition temperature of the resin material.

5. A method of manufacturing an information recording medium using the concave/convex pattern formed on the substrate by the imprinting method as claimed in claim 1.

6. A method of manufacturing an information recording medium using the concave/convex pattern formed on the substrate by the imprinting method as claimed in claim 2.

7. A method of manufacturing an information recording medium using the concave/convex pattern formed on the substrate by the imprinting method as claimed in claim 3.

8. A method of manufacturing an information recording medium using the concave/convex pattern formed on the substrate, by the imprinting method as claimed in claim 4.

9. An imprinting apparatus including heating section for heating a resin layer formed by applying a resin material to a surface of a substrate, a moving mechanism for pressing a stamper against the resin layer and removing the pressed stamper from the resin layer, and a control section for controlling the heating section and the moving mechanism, the imprinting apparatus being configured to be capable of transferring shapes of recesses/protrusions of the stamper to the resin layer to form a concave/convex pattern on the substrate,
wherein the control section causes the heating section to heat the resin layer to a predetermined temperature, and the moving mechanism to press the stamper against the resin layer, and thereafter causes the moving mechanism to remove the stamper from the resin layer while maintaining either of the state of the resin layer being heated and a state of the temperature of the heated resin layer being held.

10. An imprinting apparatus including heating section for heating a resin layer formed by applying a resin material to a surface of a substrate, a moving mechanism for pressing a stamper against the resin layer and removing the pressed stamper from the resin layer, and a control section for controlling the heating section and the moving mechanism,
the imprinting apparatus being configured to be capable of transferring shapes of recesses/protrusions of the stamper to the resin layer to form a concave/convex pattern on the substrate,
wherein the control section causes the heating section to heat the resin layer to a predetermined temperature, and the moving mechanism to press the stamper against the resin layer, and thereafter causes the heating section to terminate heating of the resin layer, and the moving mechanism to remove the stamper from the resin layer in a state of the temperature of the resin layer being substantially the same as the predetermined temperature.
